(19) United States
(12) Patent Application Publication
(10) Pub. No.: US 2025/0150468 A1
(43) Pub. Date: May 8, 2025

(54) SECURITY DESIGN SUPPORT DEVICE, SECURITY DESIGN SUPPORT METHOD, AND STORAGE MEDIUM STORING SECURITY DESIGN SUPPORT PROGRAM

(71) Applicant: DENSO CORPORATION, Kariya-city (JP)

(72) Inventors: Motonori ANDO, Kariya-city (JP); Motomasa FUTAGAMI, Kariya-city (JP); Kazuo YAMAOKA, Kariya-city (JP)

(21) Appl. No.: 18/925,106

(22) Filed: Oct. 24, 2024

(30) Foreign Application Priority Data
Nov. 2, 2023 (JP) 2023-188149

(51) Int. Cl. H04L 9/40

(52) U.S. Cl. CPC H04L 63/1416

(57) ABSTRACT

A security design support device is configured to input system information indicating a component of a system and including information indicating a subsystem; generate a first threat scenario indicating a security threat; obtain a risk level of the first threat scenario; estimate a takeover possibility that is a possibility that the subsystem is taken over using a second feasibility that is a feasibility of the first threat scenario when a necessary countermeasure is implemented against the first threat scenario of which the risk level is equal to or higher than a predetermined level; generate a second threat scenario indicating a security threat that occurs with the subsystem that is taken over as a starting point when the takeover possibility is equal to or higher than a predetermined level; and output the second threat scenario.

### CROSS REFERENCE TO RELATED APPLICATION

This application is based on Japanese Patent Application No. 2023-188149 filed on Nov. 2, 2023, the disclosure of which is incorporated herein by reference.

### TECHNICAL FIELD

The present disclosure relates to a device, a method, and a program for efficiently supporting threat analysis and risk assessment for a system.

### BACKGROUND

A related art discloses a configuration for efficiently extracting threats that may occur in the vast assets of a large-scale system, in which a database storing knowledge about threats is used to compare features of the threats in a target system with a database to identify a group of similar threats, and from a group of countermeasure policies associated with similar threats included in the group of similar threats, a countermeasure policy that appears a predetermined frequency or more among similar threats is identified.

Another related art discloses a configuration in which 5W information is input, elements constituting the 5W information are combined to generate a 5W record list representing a threat event, preconditions that define events that are clearly not a threat are input, and 5W records that represent threat events according to the preconditions are excluded from the 5W record list.

### SUMMARY

A security design support device is configured to input system information indicating a component of a system and including information indicating a subsystem; generate a first threat scenario indicating a security threat; obtain a risk level of the first threat scenario; estimate a takeover possibility that is a possibility that the subsystem is taken over using a second feasibility that is a feasibility of the first threat scenario when a necessary countermeasure is implemented against the first threat scenario of which the risk level is equal to or higher than a predetermined level; generate a second threat scenario indicating a security threat that occurs with the subsystem that is taken over as a starting point when the takeover possibility is equal to or higher than a predetermined level; and output the second threat scenario.

### BRIEF DESCRIPTION OF DRAWINGS

Objects, features and advantages of the present disclosure will become more apparent from the following detailed description made with reference to the accompanying drawings. In the drawings:

FIG. 1 is an explanatory diagram illustrating subsystems and communication paths that constitute a system;

FIGS. 2A to 2C are explanatory diagrams illustrating an example of a multi-hop threat scenario;

FIG. 3 is a block diagram illustrating an example of a configuration of a security design support device according to Embodiment 1;

FIG. 4 is an explanatory diagram illustrating an example of system information, asset information, and impact rating;

FIG. 5 is an explanatory diagram illustrating an example of a template;

FIG. 6 is an explanatory diagram illustrating an example of a first threat scenario;

FIG. 7 is an explanatory diagram illustrating an example of a first feasibility, a risk level, and a necessary security countermeasure for each first threat scenario;

FIGS. 8A and 8B are explanatory diagrams illustrating an example of a table for obtaining the first feasibility and the risk level;

FIG. 9 is an explanatory diagram illustrating an example of a second feasibility and a takeover possibility for each first threat scenario;

FIG. 10 is an explanatory diagram illustrating an example of a second threat scenario;

FIG. 11 is a flowchart illustrating an operation of the security design support device according to Embodiment 1;

FIG. 12 is a block diagram illustrating an example of a configuration of a security design support device according to Embodiment 2; and

FIG. 13 is a flowchart illustrating an operation of the security design support device according to Embodiment 2.

### DETAILED DESCRIPTION

In recent years, technologies for providing driving assistance and autonomous driving control, including V2X such as vehicle-to-vehicle communication or road-to-vehicle communication, have attracted attention. As a result, a vehicle has a communication function, and a so-called connectivity of the vehicle is progressing. As a result, a possibility that a vehicle may receive a cyber attack called unauthorized access is increasing. Therefore, it is necessary to identify, analyze, and assess the risks assumed for vehicles and reduce the assumed risks accordingly. Such risk assessment activities are summarized and recommended in ISO/SAE21434 as Threat Analysis and Risk Assessment (TARA).

The present inventor has found the following difficulties.

In threat analysis, as the number of assets, system components, and communication paths increases, the variation in the elements that configure a threat scenario increases, and the combinations of elements that configure a threat scenario increase explosively, resulting in a huge volume of threat analysis. In particular, when all threat scenarios that include threats that involve takeover of subsystems that configure the system and being caused through the taken over subsystems are created, the number thereof increases. Even further considering a case where the number of takeover is multiple times, the number thereof increases. However, when the assessment of the threat involving takeover is omitted, sufficient risk reduction may not be realized. Focusing on the fact that threats involving takeover also include a case where the takeover occurs multiple times, the expressions “multi-hop threat” and “multi-hop threat scenario” are used from now on.

The present disclosure provides a technique to implement a security design support device, and the like that reduce the amount of analysis while covering significant threat scenarios including multi-hop threat scenarios by reducing the amount of generation of multi-hop threat scenarios with low feasibility.

According to one aspect of the present disclosure, a security design support device comprises: an input unit that inputs system information indicating a component of a system and including information indicating a subsystem constituting the system as the component of the system; a threat scenario generation unit that generates a first threat scenario indicating a security threat that occurs using a predetermined component of a threat scenario from the system information and asset information indicating an asset of the system; a risk level assessment unit that obtains a risk level of the first threat scenario using a first feasibility that is a feasibility of the first threat scenario; a takeover possibility assessment unit that estimates a takeover possibility that is a possibility that the subsystem is taken over using a second feasibility that is a feasibility of the first threat scenario when a necessary countermeasure is implemented against the first threat scenario of which the risk level is equal to or higher than a predetermined level; an additional threat scenario generation unit that generates a second threat scenario indicating a security threat that occurs with the subsystem that is taken over as a starting point when the takeover possibility is equal to or higher than a predetermined level; and an output unit that outputs the second threat scenario.

With the described configuration, the security design support device, and the like of the present disclosure can reduce the amount of analysis while covering significant threat scenarios including multi-hop threat scenarios by reducing the amount of generation of multi-hop threat scenarios with low feasibility.

Hereinafter, embodiments of the present disclosure will be described with reference to the drawings.

When there are multiple embodiments (including modifications), the configurations disclosed in the embodiments are not limited to the embodiments, and can be combined across the embodiments. For example, the configuration disclosed in one embodiment may be combined with another embodiment. The configurations disclosed respectively in a plurality of embodiments may be collected and combined.

### 1. Prerequisites for Each Embodiment

### (1) System to be Targeted to Threat Analysis and the Like

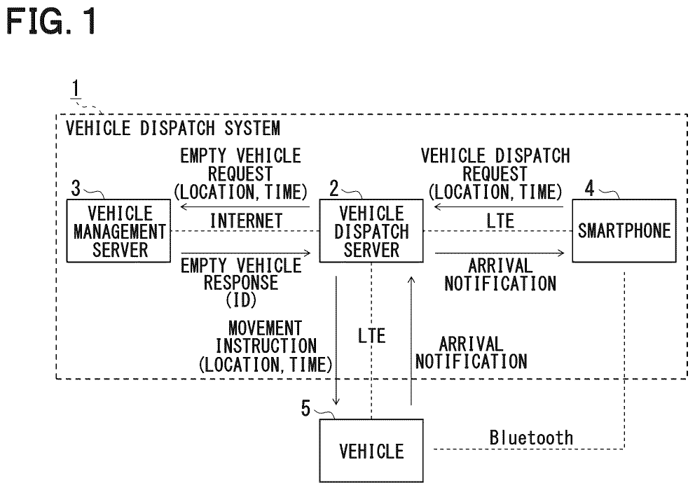

First, a system that is the target of the threat analysis and risk level assessment will be described. FIG. 1 illustrates a configuration of a vehicle dispatch system 1 as an example of a “system” that is the target of threat analysis and risk level assessment. The vehicle dispatch system 1 is configured of each “subsystem” of a vehicle dispatch server 2, a vehicle management server 3, and a smartphone 4.

The “system” refers to a combination of interacting components to realize a purpose or service.

The “subsystem” refers to a unit of components that is distinguished by dividing components into sections using physical or virtual interfaces as boundaries.

The vehicle dispatch server 2 is a device that arranges for an empty vehicle based on a vehicle dispatch request from a user.

Specifically, the vehicle dispatch server 2 receives a vehicle dispatch request including a desired location and time of vehicle dispatch from the user via the smartphone 4. The vehicle dispatch server 2 transmits an empty vehicle request to the vehicle management server 3 to inquire about an ID of an empty vehicle 5. The empty vehicle request includes the location and time the user desires to dispatch a vehicle. The vehicle dispatch server 2 receives an empty vehicle response from the vehicle management server 3 as a response to the empty vehicle request. The empty vehicle response includes the ID of the empty vehicle 5. The vehicle dispatch server 2 transmits a movement instruction to the vehicle 5 having the ID, specifying the location and time. Then, when an arrival notification is received from the vehicle 5 indicating that the vehicle 5 has arrived at the location, the vehicle dispatch server 2 transmits the arrival notification to the smartphone 4 of the user.

The vehicle management server 3 is a device that manages the vehicle.

Specifically, in response to the empty vehicle request from the vehicle dispatch server 2, the ID of the empty vehicle 5 among the vehicles under management is included in the empty vehicle response and transmitted.

The smartphone 4 is a device for requesting vehicle dispatch based on an operation of the user.

Specifically, the user transmits the vehicle dispatch request including the location and time at which the user desires to dispatch a vehicle to the vehicle dispatch server 2. When the vehicle 5 arrives at the location, the arrival notification is received from the vehicle dispatch server 2.

In the vehicle dispatch system 1 of FIG. 1, the smartphone 4 and the vehicle dispatch server 2 are connected via LTE, the vehicle dispatch server 2 and the vehicle management server 3 are connected via the Internet, the vehicle dispatch server 2 and the vehicle 5 are connected via LTE, and the smartphone 4 and the vehicle 5 are connected via Bluetooth.

In the example of FIG. 1, the vehicle 5 is not included in the system, because the vehicle 5 is not included in the target of threat analysis in the embodiment described below. In this way, it is desirable to determine the scope of a “system” based on the “subsystem” that is the target of threat analysis. However, this does not prevent the entire physical system from being defined as the “system”.

Regarding the “subsystem”, when some of the functions of the subsystem are not included in the target of the threat analysis, the scope of the function that is the target of the analysis may be limited to the “subsystem”.

The system in FIG. 1 is an example for specifically explaining each embodiment, and any system can be used in each embodiment.

### (2) Example of a Multi-Hop Threat Scenario

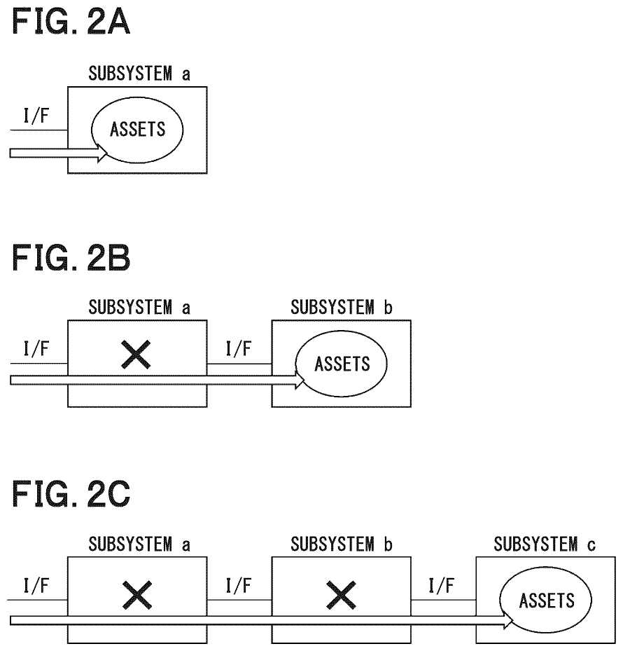

FIGS. 2A to 2C illustrate examples of multi-hop threat scenarios. The threat scenario in FIG. 2A is “an external attacker attacks an asset of a subsystem a”. In this case, since the targeted asset is attacked directly, no subsystem takeover has occurred. The threat scenario in FIG. 2B is “the external attacker takes over the subsystem a and uses the subsystem a as a springboard to attack the asset of the subsystem b”. This is an example of a one-hop threat scenario. The threat scenario in FIG. 2C is “the external attacker takes over the subsystem a, uses the subsystem a as the springboard to take over the subsystem b, and uses the subsystem b as the springboard to attack the asset of the subsystem c”. This is an example of a two-hop threat scenario.

In each embodiment, the threat scenarios of FIGS. 2A to 2C are not generated simultaneously, but are generated sequentially. That is, first, the threat scenario of FIG. 2A is generated, and when there is a possibility that the subsystem a will be taken over after the security countermeasures in the threat scenario of FIG. 2A are taken, the threat scenario of FIG. 2B is generated. Next, the threat scenario of FIG. 2C is generated based on the possibility that the subsystem b will be taken over after the security countermeasures in the threat scenario of FIG. 2B are taken. The same is true thereafter.

### 2. Embodiment 1

### (1) Configuration of Security Design Support Device 100

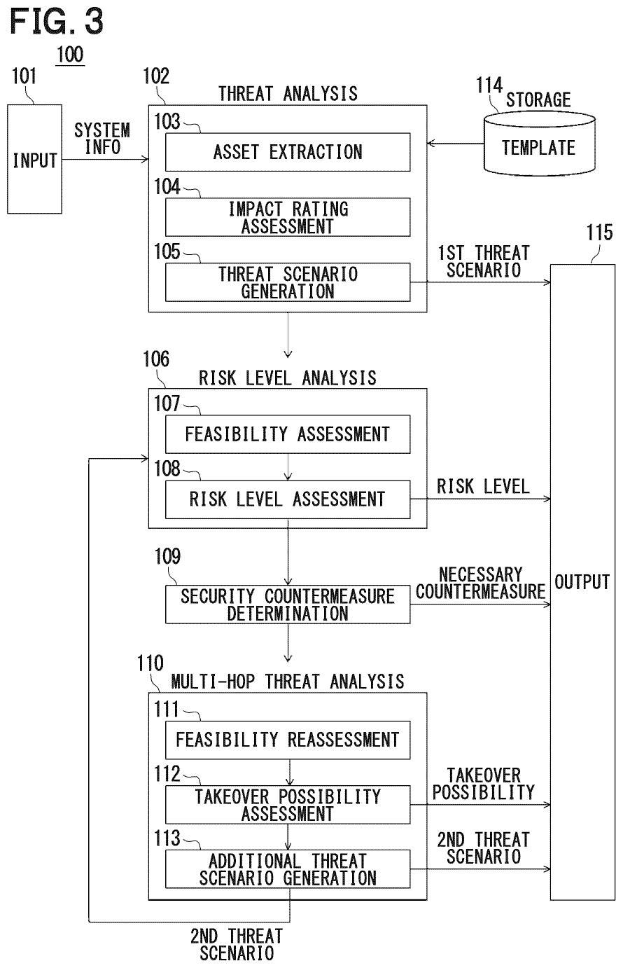

FIG. 3 is a block diagram illustrating a configuration of the security design support device 100 according to the present embodiment. The security design support device 100 includes an input unit 101, a threat analysis unit 102, a risk level analysis unit 106, a security countermeasure determination unit 109, a multi-hop threat analysis unit 110, a storage unit 114, and an output unit 115. The threat analysis unit 102 includes an asset extraction unit 103, an impact rating assessment unit 104, and a threat scenario generation unit 105. The risk level analysis unit 106 includes a feasibility assessment unit 107 and a risk level assessment unit 108. The multi-hop threat analysis unit 110 includes a feasibility reassessment unit 111, a takeover possibility assessment unit 112, and an additional threat scenario generation unit 113.

The security design support device 100 can be configured with a general-purpose CPU (Central Processing Unit), volatile memory such as RAM, non-volatile memory such as ROM, flash memory, or a hard disk, various interfaces, and an internal bus connecting these. Software is executed on the hardware, and thus a function of each functional block illustrated in FIG. 3 can be performed.

The same applies to a security design support device 200 and a security design support device 300 of the other embodiments.

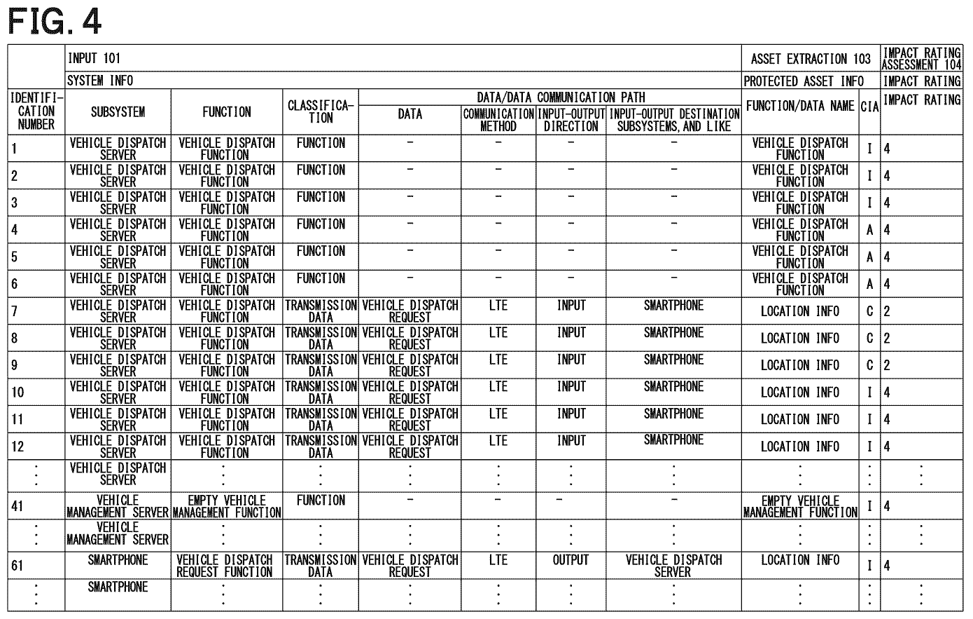

In the following description of each block, in addition to FIG. 3, FIGS. 4 to 10 will be used. FIGS. 4, 6, 7, 9, and 10 are taken as portions of one large table, and each row is connected to the same row via its identification number.

The input unit 101 inputs system information indicating the “system components” of the vehicle dispatch system 1. The system components include information indicating the subsystems that constitute the vehicle dispatch system 1. That is, the input unit 101 inputs information indicating the subsystems that constitute the vehicle dispatch system 1, in this case the vehicle dispatch server 2, the vehicle management server 3, and the smartphone 4, as well as system information indicating other “system components” related to the vehicle dispatch system 1. An example of the system information to be input is illustrated in FIG. 4. The input to the input unit 101 may be such that a human operator inputs the system information, or such that a file in which the system information is stored is read from another device or block.

The “system components” may include not only hardware, but also software and data, and furthermore, interrelationships such as sequences and data flows between hardware and software.

FIG. 4 illustrates an example of system information, asset information, and impact rating of the vehicle dispatch system 1 illustrated in FIG. 1 of the present embodiment. The system information in FIG. 4 consists of components of the vehicle dispatch system 1, and specifically, consists of a subsystem, a function of the subsystem, a classification indicating a function or data, and when the classification indicates data, a specific type of data, a communication method, an input-output direction, and a subsystem or function of an input-output destination.

According to FIG. 1, when the subsystem is the vehicle dispatch server 2, the function of the vehicle dispatch server 2 is a vehicle dispatch function or a notification function. The classification of the vehicle dispatch server 2 is function or transmission-reception data. When the classification of the vehicle dispatch server 2 is data, the data is a vehicle dispatch request, an empty vehicle request, an empty vehicle response, a movement instruction, or an arrival notification, the communication method is the Internet or LTE, the input-output direction is input or output, and the subsystem of the input destination, or the like or the smartphone 4, the vehicle management server 3, or the vehicle 5.

FIG. 4 illustrates only the case where the function is the vehicle dispatch function, the data is the vehicle dispatch request, the communication method is LTE, the input-output direction is output, and the subsystem of the input destination or the like is the smartphone 4, but basically it includes all combinations according to the number of candidates for each component. The same applies to the vehicle management server 3 and the smartphone 4 described below.

According to FIG. 1, when the subsystem is the vehicle management server 3, the function of the vehicle management server 3 is the empty vehicle management function, and the classification of the vehicle management server 3 is the function, the transmission-reception data, or the storage data. When the classification of the vehicle management server 3 is data, the data is the empty vehicle request or the empty vehicle response, the communication method is the Internet, the input-output direction is input or output, and the subsystem of the input-output destination is the vehicle dispatch server 2.

FIG. 4 illustrates only an example in which the function is the empty vehicle management function among all the combinations of system information.

According to FIG. 1, when the subsystem is the smartphone 4, the function of the smartphone 4 is the vehicle dispatch request function or the notification function, and the classification of the smartphone 4 is the function or the transmission-reception data. When the classification of the smartphone 4 is data, the data is the vehicle dispatch request or the arrival notification, the communication method is LTE or Bluetooth, the input-output direction is input or output, and the subsystem of the input-output destination or the like is the vehicle dispatch server 2 or the vehicle 5.

FIG. 4 illustrates only an example in which the function is the vehicle dispatch request function among all the combinations of system information.

The threat analysis unit 102 identifies possible security threats to the vehicle dispatch system 1 based on the system information input from the input unit 101. In the present embodiment, the threat analysis unit 102 has an asset extraction unit 103, an impact rating assessment unit 104, and a threat scenario generation unit 105 as sub-blocks.

The asset extraction unit 103 obtains asset information indicating the “asset” of the vehicle dispatch system 1 from the system information input by the input unit 101. Specifically, those are obtained by extracting the functions of the subsystems, as well as the specific data that the subsystems hold, transmit, or receive. For example, when the subsystem is the vehicle dispatch server 2, the vehicle dispatch function and notification function, as well as the location information and time information included in the vehicle dispatch request, and the like are extracted as the asset information.

The “asset” may include information and function as well as the state of the information and function.

In addition to these, the asset extraction unit 103 may further include CIA information regarding confidentiality (C), integrity (I), or availability (A) of the function and data.

The impact rating assessment unit 104 obtains the impact rating of the risk on the asset extracted by the asset extraction unit 103. The impact rating can be obtained, for example, by the method disclosed in ISO/SAE 21434 Annex F (informative) Guidelines for impact rating. The damage caused by the loss of functions, data, and the CIA set can be determined by the impact rating on each of the asset categories of security(S), finance (F), operation (O), and privacy (P), and the maximum value of the impact rating on the four asset categories can be determined as the impact rating on the asset.

The asset information in FIG. 4 illustrates only the vehicle dispatch function and the location information of the data, and omits time information.

Although the impact rating in FIG. 4 is expressed in levels of four stages, it may be expressed in other numbers or sets. The larger the impact rating is, the greater the impact is.

The threat scenario generation unit 105 generates a first threat scenario indicating a security threat that may occur using “predetermined” components (elements) of the threat scenario from the system information of the vehicle dispatch system 1 and the asset information of the vehicle dispatch system 1. In the present embodiment, the threat scenario generation unit 105 generates a first threat scenario using a template of threat scenario components. The template of the components of the threat scenario can be read out and used from, for example, those stored in the storage unit 114. The template may be in any format as long as it contains the components of the threat scenario. The template may be updated from time to time, for example, by a learning function.

The first threat scenario can also be generated using a method that does not use a template.

“Predetermined” means that it is sufficient that it is determined before the first threat scenario is generated, and it is not necessary that it is determined in an initial state of the security design support device.

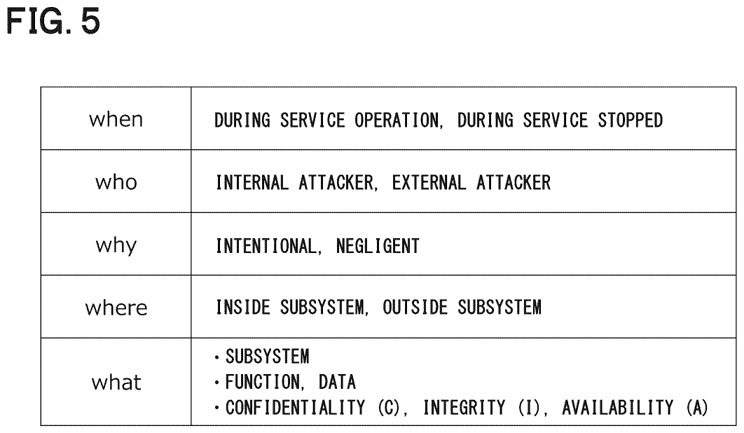

FIG. 5 illustrates an example of the template of the threat scenario component. The template in FIG. 5 abstractly lists candidates of the components of the threat scenario, consisting of occurrence time of the threat (when), the entity causing the threat (who), the intention of causing the threat (why), the starting point of the threat (where), and the target and content of the threat (what). In FIG. 5, the contents of each template are as follows. Each component may be defined in more detail than the example illustrated in FIG. 5. The content of the threat (what) may further include “takeover”.
The occurrence time of the threat (when): during service operation and during service stopped
The entity causing the threat (who): internal attacker, and external attacker
The intention of causing the threat (why): intentional and negligent
The starting point of the threat (where): inside the subsystem and outside the subsystem
The target 1 of the threat (what): subsystem
The target 2 of the threat (what): function and data
The content of the threat (what): confidentiality (C), integrity (I), and availability (A)

The threat scenario generation unit 105 generates the first threat scenario by applying the system information and the asset information to the template stored in the storage unit 114.

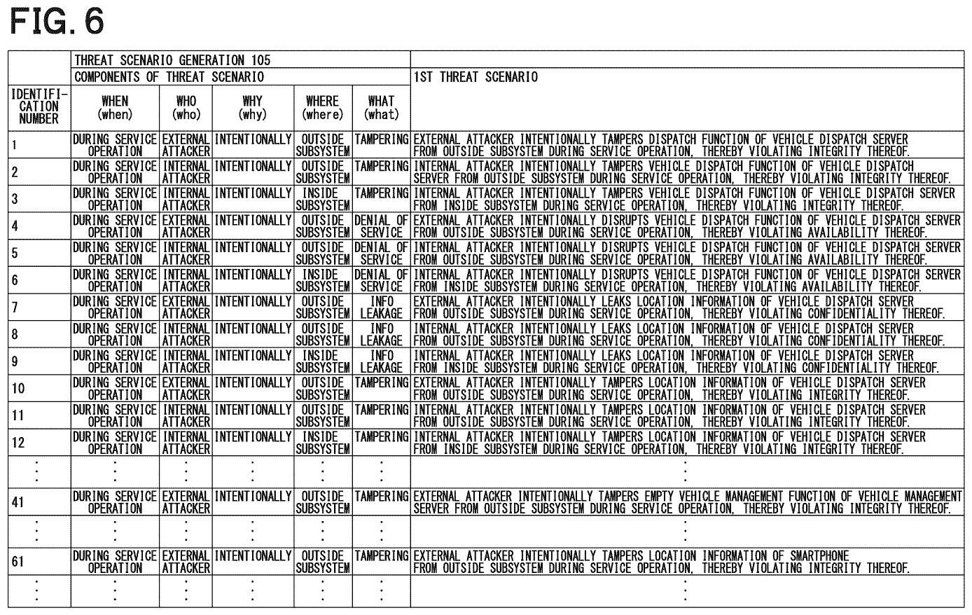

FIG. 6 illustrates a generation example of the first threat scenario generated by the threat scenario generation unit 105.

For example, in the case of identification number 1, when the candidates of the components of the threat scenario are during service operation (when), external attacker (who), intentional (why), and outside the subsystem (where), and the system information and asset information are the vehicle dispatch server 2 (what), vehicle dispatch function (what), and integrity (I) (what), the generated first threat scenario will be, “during service operation, the external attacker intentionally tampers the vehicle dispatch function of the vehicle dispatch server 2 from outside the subsystem, thereby violating integrity”. In the case of identification number 7, when the candidates of the components of the threat scenario are during service operation (when), external attacker (who), intentional (why), and outside the subsystem (where), and the system information and asset information are the vehicle dispatch server 2 (what), location information (what), and confidentiality (C) (what), the generated first threat scenario will be, “during service operation, the external attacker intentionally leaks the location information of the vehicle dispatch server 2 from outside the subsystem, thereby violating confidentiality”. Similarly, for the other identification numbers, the first threat scenario is generated using a combination of candidates of the components of the threat scenario.

FIG. 6 only lists combinations of (who) being the external attacker or the internal attacker, (where) being outside the subsystem or inside the subsystem, and (what) being tampering corresponding to integrity (I), denial of service corresponding to availability (A), or information leakage corresponding to confidentiality (C). However, for the other components as well, the first threat scenario is generated using all combinations using all candidates.

In the example of FIG. 6 of the present embodiment, the first threat scenario is generated using a combination of all components of the threat scenario and all subsystems and assets. However, the first threat scenario indicating that a fact is unlikely to happen may not be generated. For example, in the case where the asset is the function, since the confidentiality (C) of the function cannot be considered, these combinations may be excluded in advance. In the case where the asset is data, since the availability (A) of the data cannot be considered, these combinations may also be excluded in advance.

In the example of FIG. 6 of the present embodiment, since the starting point of the threat (where) is set to either inside the subsystem or outside the subsystem, multi-hop threat scenario is not generated, and only the threat scenario related to direct attack can be generated, thereby reducing the number of first threat scenarios to be generated.

The risk level analysis unit 106 obtains a risk level, which is the level of security risk of the first threat scenario, based on the first threat scenario generated by the threat scenario generation unit 105. In the present embodiment, the risk level analysis unit 106 has a feasibility assessment unit 107 and a risk level assessment unit 108 as sub-blocks.

The feasibility assessment unit 107 obtains a first feasibility, which is the feasibility of the first threat scenario generated by the threat scenario generation unit 105. For example, it can be obtained by the method disclosed in ISO/SAE 21434 Annex G (informative) Guidelines for attack feasibility rating. More specifically, the feasibility is obtained by calculating either 1) attack potential of the attack potential-based approach (Table G.7: Example attack potential mapping), 2) CVSS of CVSS-based approach (Table G.8: Example CVSS exploitability mapping), or 3) attack vector of attack vector-based approach (Table G.9: Attack vector-based approach), and determining whether the value falls within a range set for each feasibility level.

As another example, the “attack potential score”, which indicates the effort required by an attacker to realize a threat as disclosed in ISO/IEC 18045 Common Methodology for Information Technology Security Assessment, may be calculated by determining the scores for each of the parameters of “elapsed time”, “specialist expertise”, “knowledge of the system or component”, “window of opportunity”, and “equipment”, and a total value of these may be used as the first feasibility. The score values and standards for each parameter can be taken from Tables G1 to G6 in ISO/SAE 21434 Annex G (informative) or ISO/IEC 18045 B.4.2 Characterising attack potential.

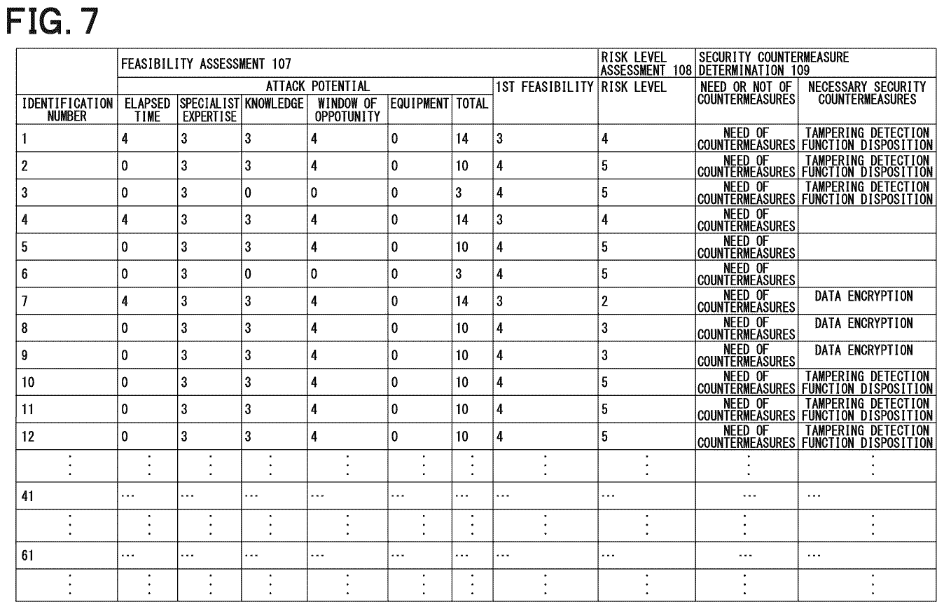

FIG. 7 illustrates an example of the first feasibility, the risk level, the necessity of security countermeasures, and need or not of the security countermeasures of the present embodiment.

The first feasibility is obtained using the other examples above. For example, the “elapsed time”, “specialist expertise”, “knowledge of the system or component (described as KNOWLEDGE in FIG. 7)”, “window of opportunity”, and “equipment” for the first threat scenario of the identification number 1 are 4, 3, 3, 4, and 0, respectively, and thereby the total value is 14. Those for the identification number 2 are 0, 3, 3, 4, and 0, and thereby the total value is 10. The higher the individual values and the total value, the higher the difficulty is.

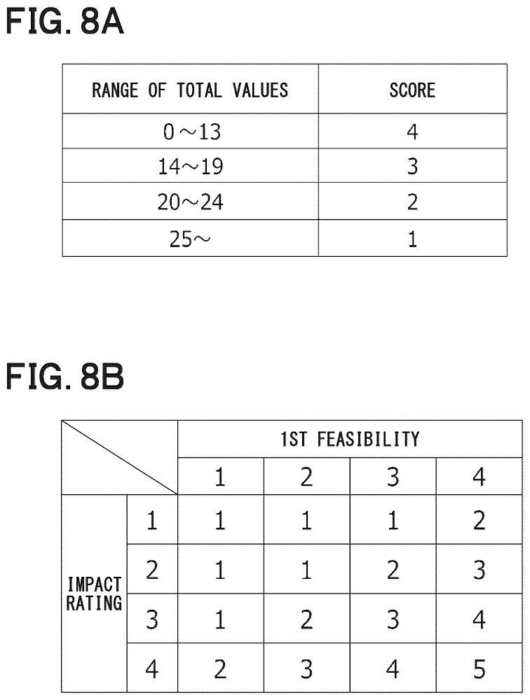

Then, the first feasibility is obtained according to the range in which the total value falls. For example, a table illustrating the relationship between the range of total values and the score indicating the first feasibility as illustrated in FIG. 8A is used. In FIG. 7, when the identification number is 1, the first feasibility is 3, and when the identification number is 2, the first feasibility is 4. The first feasibility indicates that the higher the value, the higher the feasibility is.

In FIG. 7, the first feasibility of the first threat scenario is directly obtained, but when there are multiple means or attack paths for realizing the first threat scenario, the first feasibility may be obtained for each of the means or attack paths. Also, in this case, the overall feasibility of the first threat scenario is obtained.

The risk level assessment unit 108 obtains the security risk level of the first threat scenario using the first feasibility obtained by the feasibility assessment unit 107. The risk level assessment unit 108 may further obtain the risk level using the impact rating obtained by the impact rating assessment unit 104. An example of the method for obtaining the risk level using the first feasibility and the impact rating is ISO/SAE 21434 Annex H (informative) Table H.8: Risk matrix example.

FIG. 8B illustrates an example of a table used to obtain the risk level. When the risk level is obtained using this table, in the case of the identification number 1 in FIG. 7, since the impact rating is 4 and the first feasibility is 3, the risk level is 4. Similarly, in the case of identification number 2, since the impact rating is 4 and the first feasibility is 4, the risk level is 5. The higher the risk level, the higher the risk is.

The security countermeasure determination unit 109 determines necessary countermeasures against the first threat scenario of which the risk level obtained by the risk level assessment unit 108 is “equal to or higher than” a predetermined level. For example, a necessary security countermeasure is determined for the first threat scenario having a risk level of 2 or more.

“Equal to or higher than” includes both the case where the comparison target is included (≥) and the case where the comparison target is not included (>).

Specific examples of determining necessary countermeasures include placing a program tampering detection function in a subsystem in the case of a threat against the integrity (I) of functions; encrypting the data in the case of a threat against the confidentiality (C) of stored data; placing a data encryption function and a data decryption function in the subsystem of the source and the subsystem of the destination in the case of a threat against the confidentiality (C) of transmitted data; and setting rules in advance such as rate limiting, CAPTCHA, increased delay between attempts, account locking, IP address restriction, and the use of WAF (Web Application Firewall), and determining necessary countermeasures according to the rules that apply to the first threat scenario in the case of a threat against the availability (A) of functions and data.

Well-known security countermeasures include CIS Controls, OWASP (Open Web Application Security Project) Application Security Verification Standard, and OWASP Mobile Application Security Verification Standard, and the security countermeasure determination unit 109 may determine necessary countermeasures based on these well-known rules.

In the example of FIG. 7, since all risk levels are 2 or more, all countermeasures are required for all identification numbers. For example, since the identification number 1 is a threat to the integrity (I), the tampering detection function is provided as the security countermeasure. For example, since the identification number 7 is a threat to confidentiality (C), data encryption is performed as the security countermeasure.

The multi-hop threat analysis unit 110 generates a second threat scenario, which is a multi-hop threat scenario, based on the possibility that the subsystem will be taken over when necessary security countermeasures are taken. In the present embodiment, the multi-hop threat analysis unit 110 has a feasibility reassessment unit 111, a takeover possibility assessment unit 112, and an additional threat scenario generation unit 113 as sub-blocks.

The feasibility reassessment unit 111 obtains a second feasibility, which is the feasibility of the first threat scenario when the necessary countermeasures determined by the security countermeasure determination unit 109 are implemented.

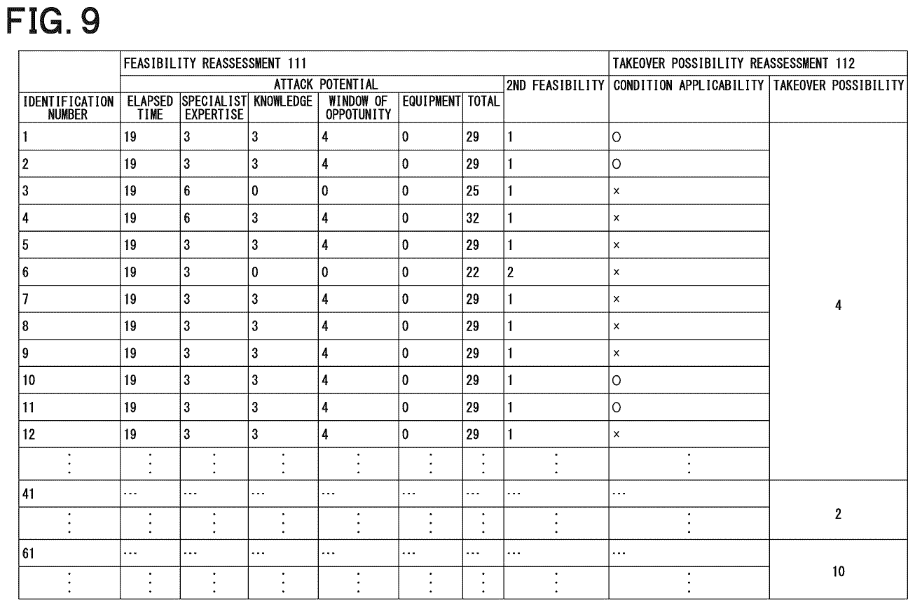

FIG. 9 illustrates an example of the second feasibility and takeover possibility of the present embodiment. The term “KNOWLEDGE” in FIG. 9 is an abbreviation for knowledge of the system or component.

Since the first feasibility of the first threat scenario in FIG. 7 is the feasibility before security countermeasures are implemented, whereas the second feasibility of the first threat scenario in FIG. 9 is the feasibility after security countermeasures are implemented, the latter is less feasible than the former.

For example, in FIG. 7, the elapsed time in the first threat scenario of the identification number 7 is 4, whereas in FIG. 9, the elapsed time in the first threat scenario after the data encryption is implemented is 19. That is, since it takes a considerable amount of time to decrypt the encrypted data, the elapsed time differs before and after the security countermeasures are implemented. As a result, the total values are also different.

The method by which the feasibility reassessment unit 111 obtains the second feasibility is the same as the method by which the feasibility assessment unit 107 obtains the first feasibility. That is, the table in FIG. 8A is used to obtain the score that is the second feasibility. In the case of FIG. 9, since the identification number 1 has the total value of 29, the second feasibility is 1, and since the identification number 6 has the total value of 22, the second feasibility is 2. Although there is no first threat scenario in FIG. 9 for which no security countermeasures are required, for the first threat scenario for which no security countermeasures are required, the first feasibility is treated as the second feasibility as it is.

In the present embodiment, the method by which the feasibility reassessment unit 111 obtains the second feasibility is the same as the method by which the feasibility assessment unit 107 obtains the first feasibility, but this does not prevent the use of a different method.

The takeover possibility assessment unit 112 uses the second feasibility obtained by the feasibility reassessment unit 111 to estimate the takeover possibility, which is the possibility that the subsystem will be taken over. For example, among the first threat scenarios for which the second feasibility is obtained, at least one, and desirably two or more, of the first threat scenarios are identified: the starting point of the threat is outside the subsystem (condition 1), the intention of the threat is intentional (condition 2), and the content of the threat is function tampering or data tampering (condition 3). The identified first threat scenarios are classified for each subsystem that is the asset targeted by the identified first threat scenario. Then, for each subsystem, the takeover possibility is assessed based on the second feasibility of each of the first threat scenarios. For example, the takeover possibility is determined when the total value of the second feasibility is equal to or higher than a predetermined value, or when the total value of the second feasibility is the maximum value.

The starting point of the threat being outside the subsystem (condition 1) is a condition for extracting the first threat scenario that mainly matches the path of the takeover, focusing on the fact that the takeover occurs from an action outside the subsystem.

The threat intent being intentional (condition 2) is a condition for extracting the first threat scenario that mainly matches the subjective perception of the takeover, focusing on the fact that the takeover is an act of a malicious person.

The content of the threat being function tampering or data tampering (condition 3) is a condition for extracting the first threat scenario that mainly matches the result of the takeover, focusing on tampering often occurs as a result of the takeover of the system. A condition for extracting the first threat scenario that matches the means of takeover may be set.

These conditions may be used alone or in combination. When using the combination, a conditional expression using a sum or product may be set. That is, by analyzing the first threat scenario that satisfies these conditions, the takeover possibility can be objectively assessed.

By classifying the first threat scenarios identified under these conditions for each subsystem that is the target, it is possible to comprehensively assess the possibility of the takeover using the first threat scenarios possessed by the subsystem.

The total value of the second feasibility in the first threat scenarios included in the subsystem indicates how vulnerable the subsystem is as a whole, and the total value can be used as an indicator of the possibility that the subsystem will be taken over.

Alternatively, the maximum value of the second feasibility in the first threat scenario included in the subsystem can be assessed as the most vulnerable threat scenario in the subsystem, and the maximum value can be used as an indicator of the possibility that the subsystem will be taken over.

In the present embodiment, the condition is that all of (condition 1), (condition 2), and (condition 3) must be satisfied. In the example of FIG. 9, the identification numbers 1, 2, 10, and 11 satisfy the condition. Since the subsystem that is the asset in these first threat scenarios is the vehicle dispatch server 2, and the total value of the second feasibility of these first threat scenarios is 4, the takeover possibility is set to 4.

The takeover possibility of other subsystems is estimated in a similar manner. In the example of FIG. 9, the takeover possibility of the vehicle management server 3 is 2, and the takeover possibility of the smartphone 4 is 10. The higher the level number, the higher the takeover possibility is.

In a case where the takeover possibility estimated by the takeover possibility assessment unit 112 is “equal to or higher than” a predetermined level, the additional threat scenario generation unit 113 generates the second threat scenario indicating a security threat that may occur with the subsystem that will be taken over as the starting point. More specifically, the additional threat scenario generation unit 113 generates the second threat scenario by rewriting the starting point of the threat in the first threat scenario generated by the threat scenario generation unit 105 from “outside the subsystem” to “the subsystem that will be taken over”.

“Equal to or higher than” includes both the case where the comparison target is included (≥) and the case where the comparison target is not included (>).

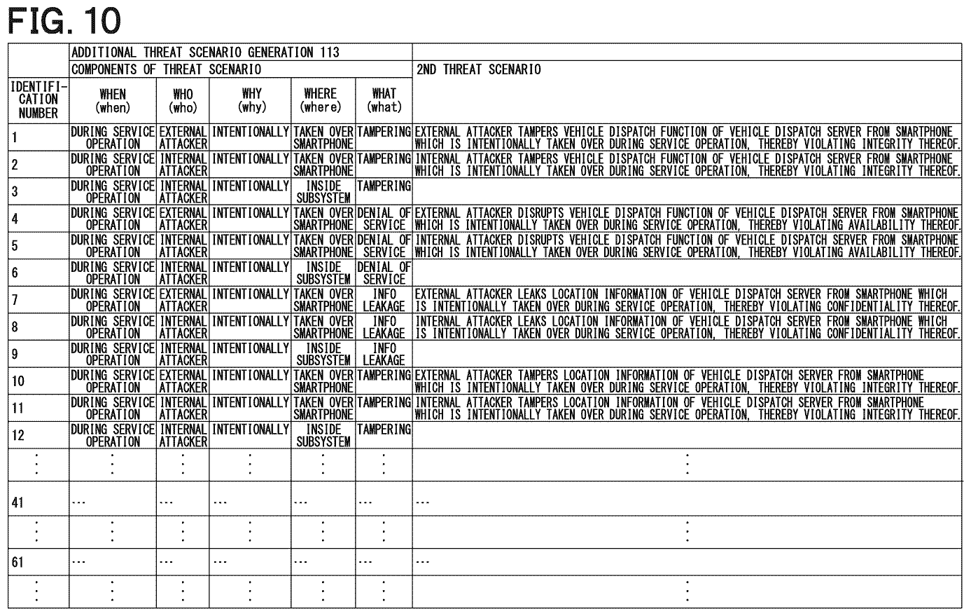

FIG. 10 illustrates a generation example of the second threat scenario generated by the additional threat scenario generation unit 113.

In FIG. 9, for example, when the predetermined level is set to 10, the vehicle dispatch server 2 and the vehicle management server 3 are assessed as will not be taken over, but the smartphone 4 is assessed as will be taken over. Then, the additional threat scenario generation unit 113 extracts subsystems that have a direct connection relationship with the smartphone 4 from the first threat scenario generated by the threat scenario generation unit 105. According to FIG. 1, the subsystem having a direct connection relationship with the smartphone 4 is the vehicle dispatch server 2. Therefore, the additional threat scenario generation unit 113 extracts the first threat scenario in which the vehicle dispatch server 2 is the subsystem that is the asset, and rewrites the starting point (where) of the threat of the components of the threat scenario from “outside the subsystem” to “the taken over smartphone 4”. For example, when rewriting the first threat scenario for the identification number 1, it is rewritten as “an external attacker tampers the vehicle dispatch function of the vehicle dispatch server 2 from the smartphone 4 which is intentionally taken over during the service operation, thereby violating the integrity thereof”. The rewritten threat scenario is then designated as the second threat scenario.

The first threat scenario, in which the starting point of the threat is “inside the subsystem”, is a threat scenario that is completed inside the subsystem, and therefore does not need to be used to generate the second threat scenario. That is, in FIG. 10, only the identification numbers 1, 2, 4, 5, 7, 8, 10, and 11 are used to generate the second threat scenario, and the identification numbers 3, 6, 9, and 12 are not used to generate the second threat scenario because they are not related to takeover.

In other words, the additional threat scenario generation unit 113 can generate only multi-hop threat scenarios where the takeover possibility is equal to or higher than a certain level. As a result, the number of second threat scenarios to be generated can be reduced.

The additional threat scenario generation unit 113 outputs the second threat scenario to the risk level analysis unit 106. Then, the feasibility assessment unit 107 and the risk level assessment unit 108 constituting the risk level analysis unit 106 use the second threat scenario to obtain the first feasibility and the risk level. Then, using the obtained risk level, the security countermeasure determination unit 109 determines necessary countermeasures against the second threat scenario.

In this way, by re-determining the risk level and necessary countermeasures using the second threat scenario, countermeasures can be taken against the first-stage multi-hop threat scenario.

Then, by further analysis being performed by the multi-hop threat analysis unit 110, a second-stage multi-hop threat scenario (corresponding to “the second threat scenario”) can be generated.

This process is then repeated and ends when all risk levels fall below a predetermined level, or when all takeover possibilities fall below a predetermined level.

A threat scenario describing a scenario before the takeover may be added to the second threat scenario. For example, first a pre-takeover threat scenario can be generated in which “the external attacker intentionally takes over the smartphone 4 from outside the subsystem during the service operation” and then a post-takeover threat scenario can be generated in which “the external attacker intentionally tampers the smartphone 4 during the service operation and uses it to tamper the vehicle dispatch function of the vehicle dispatch server 2, thereby violating the integrity thereof”, and these can be combined to form the second threat scenario.

The output unit 115 outputs the results of the blocks at each stage of the security design support device 100 to an external device such as a display device. The results to be output may be selected so that the results of the blocks at which the stages are required can be selected as required. In the case of FIG. 3, the first threat scenario generated by the threat scenario generation unit 105, the risk level assessed by the risk level assessment unit 108, the necessary countermeasures determined by the security countermeasure determination unit 109, the takeover possibility assessed by the takeover possibility assessment unit 112, and the second threat scenario generated by the additional threat scenario generation unit 113 are output.

Examples of the external device include a display device, a speaker, a storage device, a server device provided separately from the security design support device, and the like. The format of the output data may also be set appropriately in accordance with the external device. For example, image or text data, audio data, files, and the like may be mentioned. The external device may be a virtual machine realized by the same hardware as the security design support device.

### (2) Operation of Security Design Support Device 100

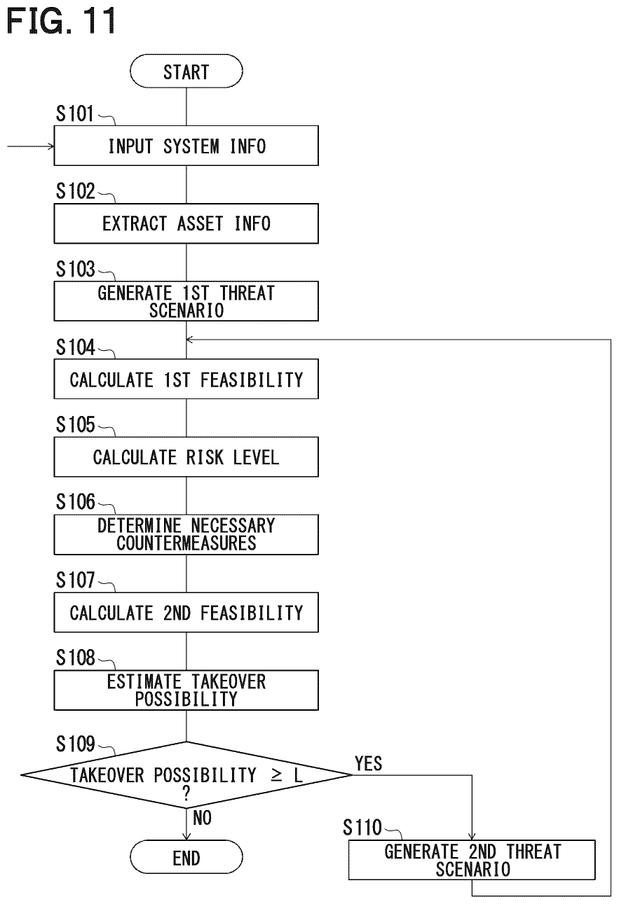

Next, an operation of the security design support device 100 will be described with reference to FIG. 11. FIG. 11 not only illustrates a security design support method executed by the security design support device 100, but also illustrates a processing procedure of a security design support program executable by the security design support device 100. The processing is not limited to the order illustrated in FIG. 11. That is, as long as there are no constraints, such as a relationship in which a step utilizes the result of a previous step, the order may be changed. The same applies to other embodiments.

System information indicating components of the vehicle dispatch system 1 is input from the input unit 101 (S101). The system information includes information indicating the vehicle dispatch server 2, the vehicle management server 3, and the smartphone 4, which are subsystems constituting the vehicle dispatch system 1.

The asset extraction unit 103 extracts and obtains asset information indicating the asset of the vehicle dispatch system 1 from the system information input in S101 (S102).

The threat scenario generation unit 105 generates the first threat scenario indicating a security threat that may occur using predetermined components of the threat scenario from the system information input in S101 and the asset information obtained in S102 (S103).

The feasibility assessment unit 107 calculates and obtains a first feasibility, which is the feasibility of the first threat scenario obtained in S103 (S104).

The risk level assessment unit 108 calculates and obtains the risk level of the first threat scenario using the first feasibility obtained in S104 (S105).

The security countermeasure determination unit 109 determines necessary countermeasures against the first threat scenario of which the risk level obtained in S105 is equal to or higher than a predetermined level (S106).

The feasibility reassessment unit 111 calculates and obtains a second feasibility, which is the feasibility of the first threat scenario when the necessary countermeasures determined in S106 are implemented (S107).

The takeover possibility assessment unit 112 estimates the takeover possibility, which is the possibility that the subsystem will be taken over, using the second feasibility obtained in S107 (S108).

When the takeover possibility obtained in S108 is equal to or higher than a predetermined level (L) (S109: Yes), the additional threat scenario generation unit 113 generates the second threat scenario indicating the security threat that may occur with the subsystem that will be taken over as the starting point (S110), and returns the processing to S104. When the takeover possibility is less than the predetermined level (L) (S109: No), the processing ends.

If necessary, the information obtained in each step may be output from the output unit 115. For example, the output unit 115 outputs the second threat scenario generated in S110.

### (3) Overview

As described above, according to the present embodiment, the security design support device 100 provides the following technical effects.

Since the first threat scenario, which is the threat scenario relating to the direct attack, and the second threat scenario, which is the threat scenario relating to the multi-hop attack, are generated in a stepwise manner, it is possible to suppress the generation of threat scenarios with low feasibility.

Since the first threat scenario is generated using predetermined components of the threat scenario, the threat scenario can be automatically generated using a computer and other devices, and past knowledge can be incorporated, so that a threat scenario without any omissions can be generated.

Among the components of the threat scenario, the starting point of the threat is set to be either inside the subsystem or outside the subsystem, so that first only the first threat scenario regarding the direct attack can be generated. The first threat scenario in which the starting point of the threat is outside the subsystem can be used to generate the second threat scenario regarding the multi-hop attack.

Since the takeover possibility, which is the possibility that a subsystem will be taken over, is assessed using the second feasibility, which is the feasibility when necessary countermeasures are taken against the first threat scenario, the accuracy of estimating the takeover possibility can be improved. Since the direct fact of the subsystem being taken over cannot be directly observed, it can be assessed using an indirect fact that is observed when the subsystem is taken over.

Since the subsystem whose takeover possibility is equal to or higher than a predetermined level is identified and the second threat scenario with the subsystem as the starting point of the attack is generated, it is possible to generate only the multi-hop threat scenarios having feasibility, and to suppress the generation of the multi-hop threat scenarios with low feasibility.

Since the second threat scenario is generated by rewriting the starting point of the threat in the first threat scenario to the subsystem that will be taken over, the second threat scenario can be generated using the first threat scenario that has already been generated, thereby reducing the amount of work required to generate the second threat scenario.

### 3. Embodiment 2

### (1) Configuration of Security Design Support Device 200

Embodiment 1 is an example in which all processing and calculations are performed by the security design support device 100 based on the system information input to the input unit 101. However, it is not necessary for all processing and calculations to be performed by the security design support device 100, and the results of processing and calculations performed by other devices may be received and used, or information generated by a person may be input and used along the way. The present embodiment is an example in which it is assumed that some of the processing and calculations are performed outside, including by a person.

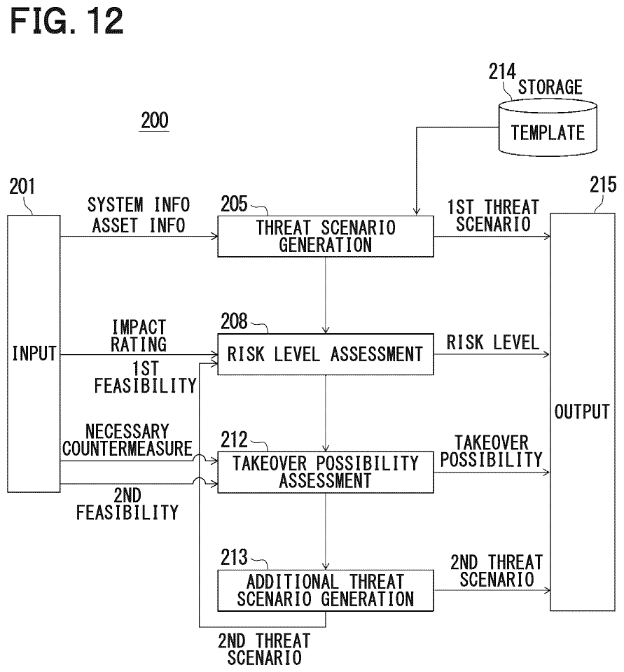

A configuration of the present embodiment will be described below with reference to FIG. 12.

FIG. 12 is a block diagram illustrating the configuration of the security design support device 200 according to the present embodiment. The security design support device 200 has an input unit 201, a threat scenario generation unit 205, a risk level assessment unit 208, a takeover possibility assessment unit 212, an additional threat scenario generation unit 213, a storage unit 214, and an output unit 215.

Among the blocks of Embodiment 1, blocks of the present embodiment that have the same last two digits of the block number basically have the same functions except for the source of information input, so the explanation of Embodiment 1 (excluding the source of information input) will be quoted.

The input unit 201 inputs various information such as the system information of the vehicle dispatch system 1, the asset information of the vehicle dispatch system 1, the impact rating, the first feasibility, the necessary countermeasures, and the second feasibility. The timing of the input is arbitrary, but as described below, it is desirable to input the information sequentially based on intermediate processing or calculation results of the security design support device 200 output from the output unit 215, or after confirming the processing or calculation results.

The various information input to the input unit 201 may be information generated by other devices or blocks, or information generated by a person's thought.

The following description will be given as an example of a case where information generated by a person's thought is sequentially input after confirming the processing and calculation results output to a display or the like.

The threat scenario generation unit 205 generates the first threat scenario indicating a security threat that may occur from the system information and asset information input from the input unit 201 using predetermined components of the threat scenario.

The generated first threat scenario is output to the output unit 215.

After the first threat scenario is confirmed by the output unit 215, the impact rating and the first feasibility, which is the feasibility of the first threat scenario, are input from the input unit 201.

The risk level assessment unit 208 uses the first feasibility input from the input unit 201 to obtain the risk level of the first threat scenario. The risk level assessment unit 208 may further use the impact rating input from the input unit 201 to obtain the risk level.

The obtained risk level is output to the output unit 215.

After the risk level is confirmed by the output unit 215, necessary countermeasures are input from the input unit 201 against the first threat scenario of which the risk level is equal to or higher than a predetermined level. Furthermore, the second feasibility, which is the feasibility of the first threat scenario when necessary countermeasures are taken, is input.

The takeover possibility assessment unit 212 estimates the takeover possibility, which is the possibility that the subsystem will be taken over, using the second feasibility input from the input unit 201.

The obtained takeover possibility is output to the output unit 215.

When the takeover possibility estimated by the takeover possibility assessment unit 212 is “equal to or higher than” a predetermined level, the additional threat scenario generation unit 213 generates the second threat scenario indicating a security threat that may occur with the subsystem that will be taken over as the starting point.

The generated second threat scenario is output to the output unit 215.

The additional threat scenario generation unit 213 outputs the second threat scenario to the risk level assessment unit 208.

After the second threat scenario is confirmed by the output unit 215, the first feasibility, which is the feasibility of the second threat scenario, is input from the input unit 201.

The risk level assessment unit 208 uses the first feasibility input from the input unit 201 to obtain the risk level of the second threat scenario.

This processing is repeated and ends when all risk levels fall below a predetermined level, or when all takeover possibilities fall below a predetermined level.

### (2) Operation of Security Design Support Device 200

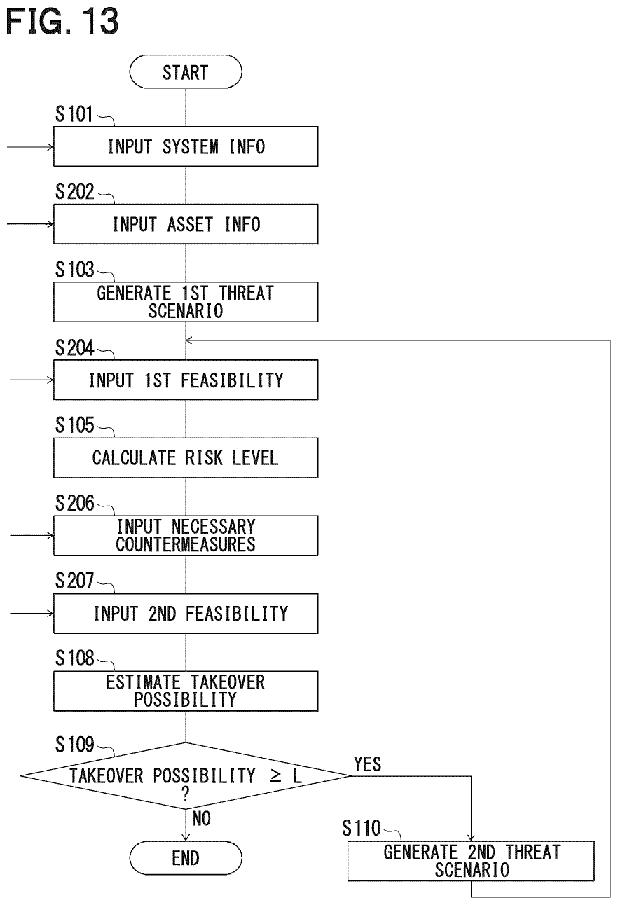

Next, an operation of the security design support device 200 will be described with reference to FIG. 13.

A difference between FIG. 11 which illustrates the operation of the security design support device 100 of Embodiment 1 and FIG. 13 which illustrates the operation of the security design support device 200 of the present embodiment is that in FIG. 11, extraction of the asset information (S102), calculation of the first feasibility (S104), determination of the necessary countermeasures (S106), and calculation of the second feasibility (S107) are changed to input of asset information (S202), input of the first feasibility (S204), input of the necessary countermeasures (S206), and input of the second feasibility (S207), respectively. The flow having the same step numbers as in FIG. 11 has the same processing as in FIG. 11 except for the input source of the information.

The system information indicating the components of the vehicle dispatch system 1 is input from the input unit 201 (S101).

The asset information indicating the asset of the vehicle dispatch system 1 is input from the input unit 201 (S202).

The threat scenario generation unit 205 generates the first threat scenario indicating the security threat that may occur using predetermined components of the threat scenario from the system information input in S101 and the asset information input in S202 (S103).

The first feasibility, which is the feasibility of the first threat scenario obtained in S103, is input from the input unit 201 (S204).

The risk level assessment unit 208 calculates and obtains the risk level of the first threat scenario using the first feasibility input in S204 (S105).

Necessary countermeasures against the first threat scenario of which the risk level is equal to or higher than a predetermined level as obtained in S105, are input from the input unit 201 (S206).

The second feasibility, which is the feasibility of the first threat scenario when the necessary countermeasures input in S206 are implemented, is input from the input unit 201 (S207).

The takeover possibility assessment unit 212 estimates the takeover possibility, which is the possibility that the subsystem will be taken over, using the second feasibility input in S207 (S108).

When the takeover possibility obtained in S108 is equal to or higher than a predetermined level (L) (S109: Yes), the additional threat scenario generation unit 213 generates the second threat scenario indicating the security threat that may occur with the subsystem that will be taken over as the starting point (S110), and the processing returns to S204. When the takeover possibility is less than the predetermined level (L) (S109: No), the processing ends.

If necessary, the information obtained in each step may be output from the output unit 215. For example, the output unit 215 outputs the second threat scenario generated in S110.

### (3) Overview

According to the present embodiment, the security design support device 200 has the following effects in addition to the effects of Embodiment 1.

Since the asset information, the first feasibility, the necessary countermeasures, and the second feasibility are input from the input unit, there is no need to provide a block in the security design support device 200 that analyzes and calculates these, and the burden on the security design support device 200 can be reduced.

### 4. Other Embodiments

The security design support device 300 of the present embodiment has a configuration intermediate between the security design support device 100 of Embodiment 1 and the security design support device 200 of Embodiment 2.

That is, in Embodiment 1, the asset information is extracted by the asset extraction unit 103, the first feasibility is obtained by the feasibility assessment unit 107, the necessary countermeasures are determined by the security countermeasure determination unit 109, and the second feasibility is obtained by the feasibility reassessment unit 111. In contrast to this, in Embodiment 2, this information is not generated within the security design support device 200 but is input from the input unit 201. That is, it is generated outside the security design support device 200.

However, it is not necessary for all of this information to be generated either inside or outside the security design support device, at least a part of this information may be generated inside the security design support device, and the rest may be generated outside the security design support device and input. That is, the security design support device 300 of the present embodiment may have at least one of the asset extraction unit 103, the feasibility assessment unit 107, the security countermeasure determination unit 109, and the feasibility reassessment unit 111, in addition to the configuration of the security design support device 200 of Embodiment 2. Alternatively, the security design support device 300 of the present embodiment may further input at least one of the asset information, the first feasibility, the necessary countermeasures, and the second feasibility from the input unit 101, instead of at least one of the asset extraction unit 103, the feasibility assessment unit 107, the security countermeasure determination unit 109, and the feasibility reassessment unit 111, among the components of the security design support device 100 of Embodiment 1.

The features of the security design support device and the like in each embodiment of the present disclosure are described above.

Since terms used in the embodiments are examples, the terms may be replaced with synonymous terms or terms including synonymous functions.

The block diagrams used for the description of the embodiments are obtained by classifying and organizing the configuration of each device for each function. The blocks representing the respective functions may be implemented by any combination of hardware or software. Since the blocks represent the functions, such a block diagram may also be understood as disclosures of a method and a program for implementing the method.

An order of functional blocks that can be understood as processes, flows, and methods described in the embodiments may be changed as long as there are no restrictions such as a relation in which results of preceding processes are used in one other process.

The terms such as first, second, to N-th (where N is an integer) used in each embodiment and in the claims are used to distinguish two or more configurations and methods of the same kind and are not intended to limit the order or superiority.

Further, examples of the security design support device of the present disclosure include the following. Examples of component include a semiconductor element, an electronic circuit, a module, and a microcomputer. Examples of a form of a semi-finished product include an electric control unit (ECU) and a system board. Examples of a form of a finished product include a cellular phone, a smartphone, a tablet computer, a personal computer (PC), a workstation, and a server. Further, the examples of the form include a device having a communication function such as a video camera, a still camera, a car navigation system.

It is assumed that the security design support device of the present disclosure will be used particularly on the server side for the purpose of providing various services. In providing such services, the security design support device of the present disclosure is used, the method of the security design support device of the present disclosure is used, and/or the program of the security design support device of the present disclosure is executed.

In addition, the present disclosure can be implemented by not only dedicated hardware having the configurations and functions described in each embodiment but also as a combination of a program recorded in a recording medium such as a memory or a hard disk and provided to implement the present invention, and general-purpose hardware having a dedicated or general-purpose CPU, which can execute the program, and having a memory and the like.

A program stored in a non-transitory tangible storage medium (e.g., an external storage device such as a hard disk, a USB memory, and a CD/BD, or an internal storage device such as a RAM and a ROM) of dedicated or general-purpose hardware may also be transmitted to the dedicated or general-purpose hardware via the storage medium or via a communication line from a server without using the storage medium. Thereby, the latest functions can be provided at all times through program upgrade.

The security design support device may be intended for systems related to automobiles, but may also be used for systems not related to automobiles.

What is claimed is:

1. A security design support device comprising:
an input unit that inputs system information indicating a component of a system and including information indicating a subsystem constituting the system as the component of the system;
a threat scenario generation unit that generates a first threat scenario indicating a security threat that occurs using a predetermined component of a threat scenario from the system information and asset information indicating a asset of the system;
a risk level assessment unit that obtains a risk level of the first threat scenario using a first feasibility that is a feasibility of the first threat scenario;
a takeover possibility assessment unit that estimates a takeover possibility that is a possibility that the subsystem is taken over using a second feasibility that is a feasibility of the first threat scenario when a necessary countermeasure is implemented against the first threat scenario of which the risk level is equal to or higher than a predetermined level;
an additional threat scenario generation unit that generates a second threat scenario indicating a security threat that occurs with the subsystem that is taken over as a starting point when the takeover possibility is equal to or higher than a predetermined level; and
an output unit that outputs the second threat scenario.

2. The security design support device according to claim 1, further comprising; at least one of
an asset extraction unit that obtains the asset information from the system information;
a feasibility assessment unit that obtains the first feasibility which is a feasibility of the first threat scenario;
a security countermeasure determination unit that determines the necessary countermeasure against the first threat scenario of which the risk level is equal to or higher than the predetermined level; and
a feasibility reassessment unit that obtains the second feasibility which is a feasibility of the first threat scenario when the necessary countermeasure is implemented.

3. The security design support device according to claim 1, wherein
the input unit further inputs at least one of the asset information, the first feasibility, the necessary countermeasure, and the second feasibility.

4. The security design support device according to claim 1, wherein
the component of the threat scenario indicating the starting point of a threat is either inside the subsystem or outside the subsystem.

5. The security design support device according to claim 1, wherein
the takeover possibility assessment unit
identifies the first threat scenario that satisfies at least one of a condition that matches a path of the takeover, a condition that matches a subjective perception of the takeover, a condition that matches a result of the takeover, and a condition that matches means of the takeover, among the first threat scenario for which the second feasibility is obtained,
classifies the identified first threat scenario for each subsystem that is the asset targeted by the identified first threat scenarios and
obtains the takeover possibility for each subsystem based on the second feasibility of each of first threat scenarios.

6. The security design support device according to claim 4, wherein
the additional threat scenario generation unit generates the second threat scenario by rewriting the starting point of the threat in the first threat scenario generated by the threat scenario generation unit to the subsystem that will be taken over.

7. The security design support device according to claim 1, further comprising:
an impact rating assessment unit that obtains an impact rating of the asset on risk,
wherein
the risk level assessment unit obtains the risk level of the first threat scenario using the first feasibility and the impact rating.

8. A security design support method executed by a security design support device, comprising:
inputting system information indicating a component of a system and including information indicating a subsystem constituting the system as the component of the system;
generating a first threat scenario indicating a security threat that occurs using a predetermined component of a threat scenario from the system information and asset information indicating an asset of the system;
obtaining a risk level of the first threat scenario using a first feasibility that is a feasibility of the first threat scenario;
estimating a takeover possibility that is a possibility that the subsystem is taken over using a second feasibility that is a feasibility of the first threat scenario when a necessary countermeasure is implemented against the first threat scenario of which the risk level is equal to or higher than a predetermined level;
generating a second threat scenario indicating a security threat that occurs with the subsystem that is taken over as a starting point when the takeover possibility is equal to or higher than a predetermined level; and
outputting the second threat scenario.

9. A non-transitory computer readable storage medium storing a security design support program executable by a security design support device, causing the security design support device to execute:
inputting system information indicating a component of a system and including information indicating a subsystem constituting the system as the component of the system;
generating a first threat scenario indicating a security threat that occurs using a predetermined component of a threat scenario from the system information and asset information indicating an asset of the system;
obtaining a risk level of the first threat scenario using a first feasibility that is a feasibility of the first threat scenario;
estimating a takeover possibility that is a possibility that the subsystem is taken over using a second feasibility that is a feasibility of the first threat scenario when a necessary countermeasure is implemented against the first threat scenario of which the risk level is equal to or higher than a predetermined level;
generating a second threat scenario indicating a security threat that occurs with the subsystem that is taken over as a starting point when the takeover possibility is equal to or higher than a predetermined level; and
outputting the second threat scenario.

10. The security design support device according to claim 1, further comprising:
a processor capable of executing computer program instructions; and
a memory connected to the processor and storing the computer program instructions,
wherein
by executing the computer program instructions stored in the memory, the processor provides the input unit, the thread scenario generation unit, the risk level assessment unit, the takeover possibility assessment unit, the additional threat scenario generation unit, and the output unit, and
the security design support device evaluates security risk in a vehicle dispatch system including a vehicle dispatch server, a smartphone, and a vehicle management server as subsystems.

11. A security design support device comprising:
a processor capable of executing computer program instructions; and
a memory connected to the processor and storing the computer program instructions,
wherein
the processor, by executing the computer program instructions stored in the memory,
receives system information including information of a system to be analyzed, the system including subsystems,
generates a first scenario indicating a potential security attack that occurs using a predetermined component of scenario from the system information and information indicating functions of the subsystems or data held by the subsystems,
obtains a risk level of the first scenario using a first feasibility, which is feasibility of the first scenario, the risk level of the first scenario being determined based on the first feasibility and impact rating,
extracts the first scenario of which the risk level is equal to or higher than a predetermined level,
calculates a second feasibility, which is feasibility of the first scenario when a countermeasure is implemented against the first scenario of which the risk level is equal to or higher than the predetermined level,
estimates a takeover possibility, which is possibility that control over the subsystem is obtained, using the second feasibility,
generates a second scenario indicating a potential security attack that occurs with the subsystem that is taken over as a starting point when the takeover possibility is equal to or higher than a predetermined value, and
outputs the first scenario, the risk level, the countermeasure, the takeover possibility, and the second scenario as image data or text data, and
the security design support device evaluates security risk in a vehicle dispatch system.

12. The security design support device according to claim 11, wherein
the system information received by the processor includes information indicating a vehicle dispatch server, a smartphone, and a vehicle management server that constitute the system to be analyzed, and
the vehicle dispatch server, the smartphone, and the vehicle management server are the subsystems of the system.
